(19) United States
(12) Patent Application Publication
(10) Pub. No.: US 2011/0093486 A1
(43) Pub. Date: Apr. 21, 2011

(54) DATA QUERY METHOD, DATA QUERY SYSTEM AND COMPUTER READABLE AND WRITABLE RECORDING MEDIUM

(75) Inventors: Chuo-Yen Lin, Taipei City (TW); Yung-Feng Lu, Taipei County (TW); Pei-Lun Suei, Taichung County (TW); Shih-Chun Chou, Taipei City (TW); Tei-Wei Kuo, Taipei County (TW)

(73) Assignee: INSTITUTE FOR INFORMATION INDUSTRY, Taipei (TW)

(21) Appl. No.: 12/717,101

(22) Filed: Mar. 3, 2010

(30) Foreign Application Priority Data
Oct. 15, 2009 (TW) 98134933

(51) Int. Cl. G06F 17/30; G06F 7/00

(52) U.S. Cl. 707/760; 707/797; 707/E17.124; 707/E17.05; 707/E17.014

(57) ABSTRACT

A relational database query system for a relational database is provided, wherein the relational database comprises several relational tables including at least one constant table storing several unique data. The relational database query system comprises a query receiving module for receiving an extensible-markup-language query (XML query); at least a constant mapping tree respectively corresponds to one of the at least constant tables, wherein the at least constant mapping tree comprises several tree nodes respectively with node numbers respectively corresponding to the unique data in the at least constant table; a query generator for converting the XML query to be a structured query language (SQL) query according to the at least constant mapping tree; a query module for querying the relational database with the SQL query.

### CROSS-REFERENCE TO RELATED APPLICATION

This application claims the priority benefit of Taiwan application serial no. 98134933, filed on Oct. 15, 2009. The entirety of the above-mentioned patent application is hereby incorporated by reference herein and made a part of specification.

### BACKGROUND OF THE INVENTION

1. Field of the Invention

The invention is related to a data query method, a data query system and a computer readable and writable recording medium, and particular to a method and a system for converting an extensible-markup-language query into a improved structured-query-language query to rapidly query data, and a computer readable and writable recording medium for storing the same.

2. Description of Related Art

Among the various markup languages, the extensible markup language (XML) with the features of powerful function, accurate description, easy being written and expanded has been widely applied in the Internet and the data management. Most of the web page applications are connected to the database and use the XML to translate the data in the database into web pages or to convert the data on the web pages and then to store them into the database. However, the databases for managing the text data are usually the relational database which does not have any hierarchical relationship. The XML query command often cannot be used for querying data from the relational database. Thus, the conversion interface for converting the XML query commands into the accessing commands for accessing the data in the relational database is developed.

FIG. 1 is a schematic view of a conventional data query method. FIG. 2 is a schematic view showing a conventional relational database. FIG. 3 is a schematic view showing a module mapping method for converting an XML database into a relational database. As shown in FIG. 1, the user inputs the query criteria through a web page interface 100 so as to generate an XML query command 102, and a conversion interface 104 converts the XML query command into a query command capable accessing the relational database 106. The relational database system executes the query commands to implement several join operations 108 on a plurality of relational tables 110 in the relational database 106 and obtain the query result, and then the query result is converted into the XML-based query result by the conversion interface 104. Thus, the XML-based query result, in a form of web page, is presented on the user's display.

As shown in FIG. 2, the conventional relational database comprises a plurality of relational tables such as the relational table for recording data paths (table LabelPath 204a), the relational table for recording data contents (table Data 204b), the relational table for recording hierarchy (table DataPath 204c) and the relational table for recording the data storing orders (table element 204d). However, in the conventional technique, when the XML query command 302 is converted into the query command capable of accessing the relational database, mass of join operations of the relational tables are generated accordingly. As shown in FIG. 3, the XML query command 302 queries “the films which the celebrity Will Smith was involved in during 2007”. However, the query command 304 converted from the XML query command 302 has 18 join operations. The more the number of the join operations is, the slower the query rate is. Therefore, the user wastes a lot of time for waiting the join operations of the relational database system.

### SUMMARY OF THE INVENTION

The invention provides a data query method, a data query system and a computer readable and writable recording medium of the relational database, which are capable of converting the extensible-markup-language query into an improved structured-query-language query.

The invention provides a data query method, a data query system and a computer readable and writable recording medium of the relational database, which are capable of reducing the number of the join operations of the relational tables in the data query procedure.

The invention provides a data query method, a data query system and a computer readable and writable recording medium of the relational database, which are capable of increasing the data query rate.

The invention provides a data query method of a relational database, adapted for a query system to query the relational database through at least a constant mapping tree, wherein the relational database has a plurality of relational tables, and the relational tables includes at least a constant table recording a plurality of unique data, and each of the at least constant mapping tree corresponds to one of the at least constant tables respectively, and each of the at least constant mapping trees has a plurality of tree nodes, and each of the tree nodes has a node number, and each of the node numbers corresponds to one of the unique data respectively. The data query method comprising: receiving an extensible-markup-language query and converting the extensible-markup-language query into an improved structured-query-language query according to the at least constant mapping tree. Then, a data query implemented on the relational database by using the improved structured-query-language query.

The invention provides a data query system of a relational database, wherein the relational database has a plurality of relational tables, and the relational tables includes at least a constant table recording a plurality of unique data. The data query system comprises a query receiving module, at least a constant mapping tree, a query generator and a query module. The query receiving module is used to receive an extensible-markup-language query. Each of the at least constant mapping tree corresponds to one of the at least constant tables respectively, and each of the at least constant mapping trees has a plurality of tree nodes, and each of the tree nodes has a node number, and each of the node numbers corresponds to one of the unique data respectively. The query generator is used to convert the extensible-markup-language query into an improved structured-query-language query according to the at least constant mapping tree. The query module is used to implement a data query on the relational database by using the improved structured-query-language query.

The invention provides a computer readable and writable recording medium for storing a data query program, at least a constant mapping tree and a relational database, wherein the relational database has a plurality of relational tables, and the relational tables includes at least a constant table recording a plurality of unique data, and each of the at least constant mapping tree corresponds to one of the at least constant tables respectively, and each of the at least constant mapping trees has a plurality of tree nodes, and each of the tree nodes has a node number, and each of the node numbers corresponds to one of the unique data respectively. The data query program comprises: a first programming code for receiving an extensible-markup-language query; a second programming code for converting the extensible-markup-language query into an improved structured-query-language query according to the at least constant mapping tree; and a third programming code for implementing a data query on the relational database by using the improved structured-query-language query.

Furthermore, in the data query method, the data query system and the computer readable and writable recording medium of the present invention, the extensible-markup-language query converted into the improved structured-query-language query further comprises converting the extensible-markup-language query into an original structured-query-language query, wherein the original structured-query-language query has a plurality of predicates. Portions of the predicates corresponding to the unique data in the at least constant table are modified by referring to the node numbers of the unique data corresponding to the portion of the predicates.

Moreover, in the data query method, the data query system and the computer readable and writable recording medium of the present invention, the relational database includes an extensible-markup-language-based relational database.

Further, in the data query method, the data query system and the computer readable and writable recording medium of the present invention, the relational database is built-up by using a module mapping method according to an extensible-markup-language database. Also, each of the unique data of the at least constant table represents a hierarchy path of the extensible-markup-language database. Further, a node hierarchy relationship between the tree nodes of the at least constant mapping tree complies with the data hierarchy relationship represented by each of the unique data.

In addition, in the data query method, the data query system and the computer readable and writable recording medium of the present invention, there is no foreign key set in the at least constant table.

Furthermore, in the data query method, the data query system and the computer readable and writable recording medium of the present invention, each of the node number corresponds to a unique identification number of each of the unique data.

In the data query method, the data query system and the computer readable and writable recording medium of the present invention, the received extensible-markup-language query is converted into a high performance structured-query-language query by combining and replacing portions of the predicates sets with the node numbers of the at least constant mapping tree. Therefore, the number of the join operations is decreased and the rate of data query of the relational database is greatly increased. Thus, the time for waiting for the data query is decreased and the query efficiency is increased.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional data query method.

FIG. 2 is a schematic view showing a conventional structure mapping method for converting an XML database into a relational database.

FIG. 3 is a schematic view showing a module mapping method for converting an XML database into a relational database.

FIG. 4A is a schematic view of a data query system according to one embodiment of the present invention.

FIG. 4B is a schematic view of a data query system according to another embodiment of the present invention.

FIG. 5 is a schematic view of a data schema of a database in a data query system according to one embodiment of the present invention.

FIG. 6A is a flow chart showing a data query method according to one embodiment of the present invention.

FIG. 6B is a flow chart showing method for building up a constant mapping tree according to another embodiment of the present invention.

FIG. 7 is a schematic view showing the process for generating an improved structured-query-language query in a query generator according to one embodiment of the present invention.

FIG. 8 is a structural schematic view of a constant mapping tree built by using red-black tree algorithm according to one embodiment of the present invention.

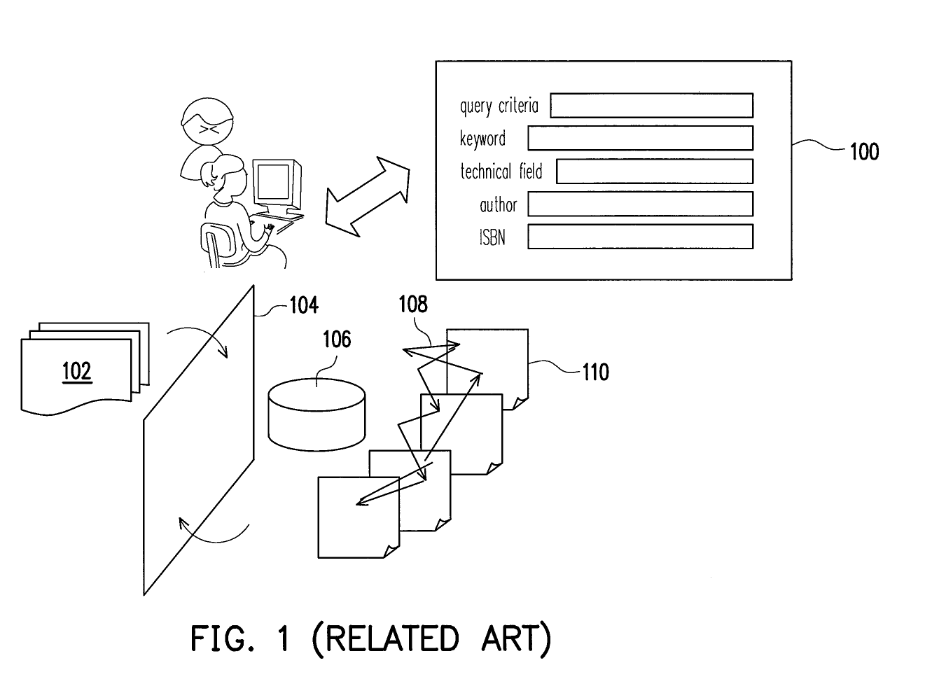

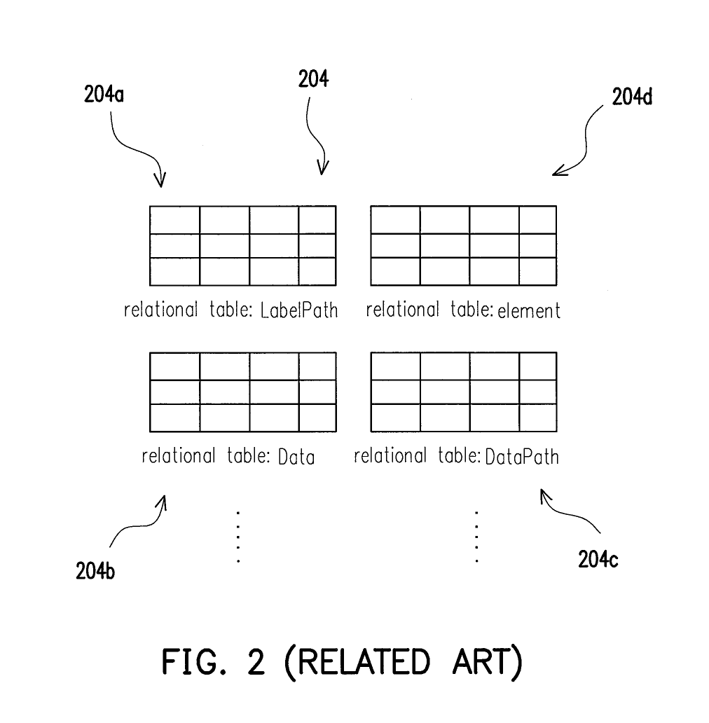

### DESCRIPTION OF EMBODIMENTS

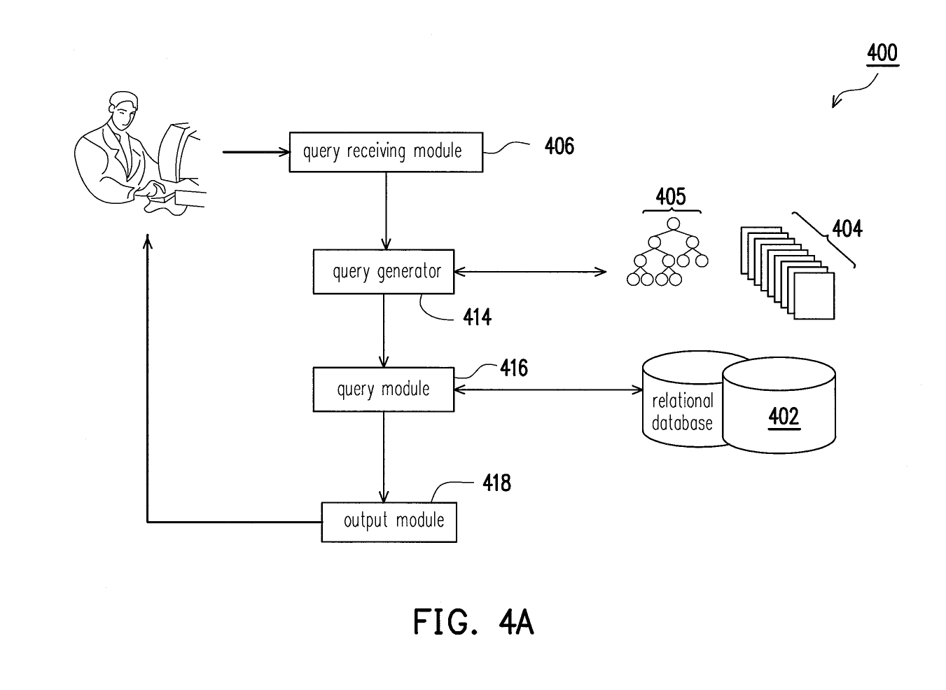

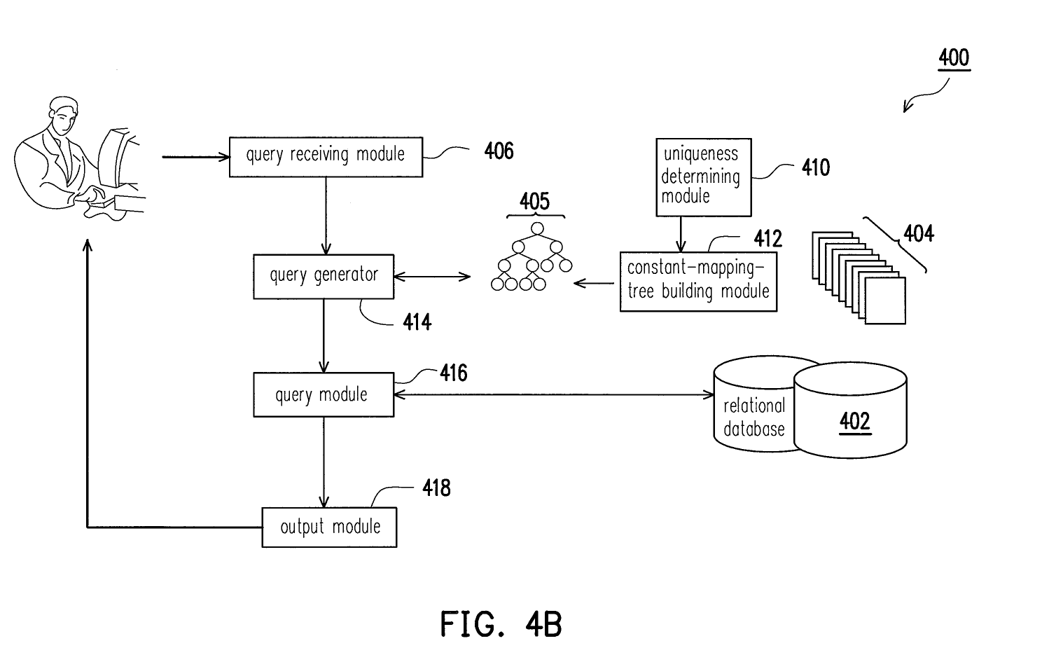

FIG. 4A is a schematic view of a data query system of a relational database according to one embodiment of the present invention. As shown in FIG. 4A, a data query system 400 is implemented with a relational database 402. The relational database 402 has a plurality of relational tables 404. The data query system 400 comprises at least a constant mapping tree 405. The embodiment shown in FIG. 4A takes the data query system 400 having one constant mapping tree 405 as an example, but the present invention is not limited to. That is, the data query system 400 can have at least one constant mapping tree 405 according to the practical requirement. The data query system 400 further comprises a query receiving module 406, a query generator 414, a query module 416 and an output module 418.

Furthermore, in another embodiment of the present invention, the data query system 400 further comprises a uniqueness determining module 410 and a constant-mapping-tree building module 412, as shown in FIG. 4B. It should be noticed that, the elements in FIG. 4B as same as the elements in FIG. 4A in labeled numbers are also the same in functionalities and are not described repeatedly.

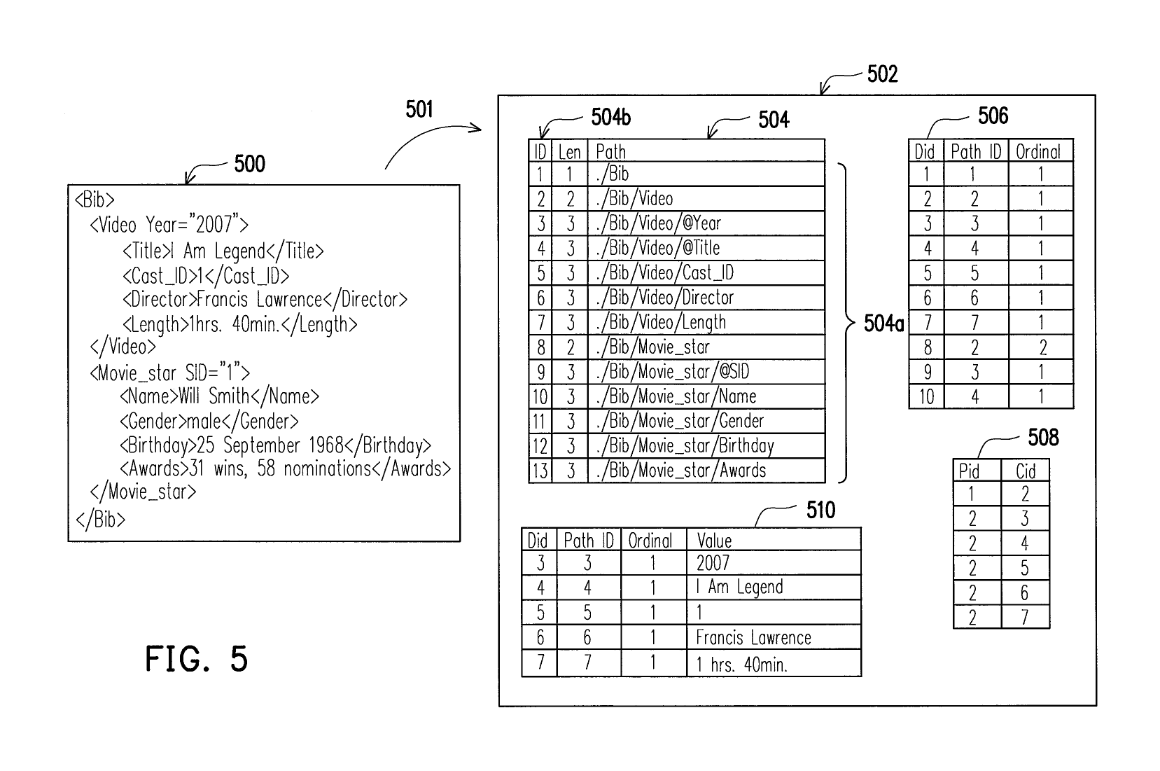

FIG. 5 is a schematic view of a data schema of a database in a data query system according to one embodiment of the present invention. As shown in FIG. 5, in the present embodiment, the relational database 402 can be, for example, an extensible-markup-language-based relational database (XML-based relational database). In other words, the relational database 402 can be built-up by using a module mapping method 501 according to an extensible-markup-language database (XML database) 500. Furthermore, in another embodiment, the relational database 402 can also be built-up by using a structure mapping method according to the XML database 500. As shown in FIG. 5, the XML-based relational database 502 has a plurality of relational tables including a path table 504 for recording a hierarchy path of each of the data in the XML database 500, an order table 506 for recording data orders of the data in the XML database 500, a hierarchy relationship table 508 for recording data hierarchy relationships between the data in the XML database 500 and a data content table 510 for recording data contents of the data in the XML database.

In the present embodiment, in the path table 504 for recording the hierarchy path of each of the data in the XML database, each of the recorded data representing a hierarchy path 504a has a one-on-one feature, which is so-called uniqueness. Hence, the path table 504 is regarded as a constant table. The at least constant mapping tree 405 shown in FIG. 4A corresponds to the at least constant table 504 of the XML-based relational database 502. In other embodiments, the database can include at least one constant table, and each of the at least constant tables corresponds to one of the at least constant mapping tree respectively.

In the aforementioned embodiment, the at least constant mapping tree 405 has a plurality of tree nodes with node numbers respectively, and each of the node numbers corresponds to one of the unique data 504a in the at least constant table 504 respectively. In some embodiments, the at least constant mapping tree 405 can be built by, for example, adopting Hash table or other rapid data searching method. Further, the Hash table records each of the tree nodes of the at least constant mapping tree 405 and the unique data stored in the at least constant table 504 respectively corresponding to the recorded tree nodes. In another embodiment, the at least constant table 504 further comprises a unique identification field for storing identification numbers, which are one-on-one corresponding to the unique data 504a in the at least constant table 504 as shown in the ID number in the ID field 504b of the path table 504. In the other embodiment, the unique identification numbers can be the random numbers generated by the random generator so that the unique identification numbers are not repeated. Preferably, the node number of each of the tree nodes of the at least constant mapping tree 405 is the unique identification number in the ID field 504b of the unique data 504a, which is corresponding to the node number.

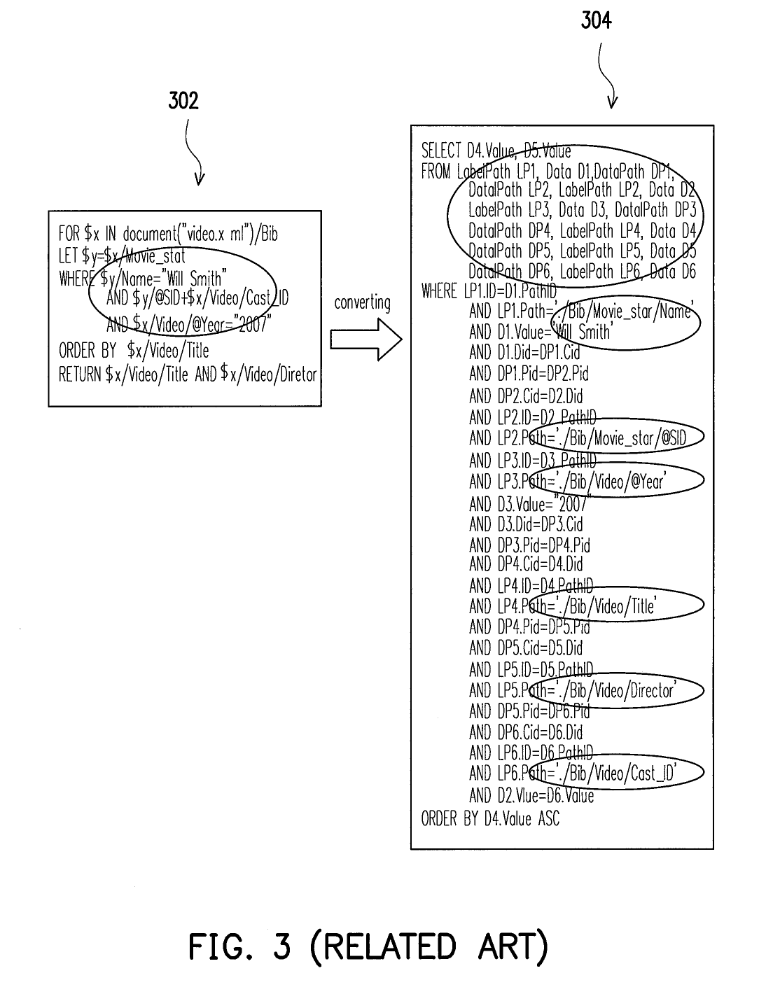

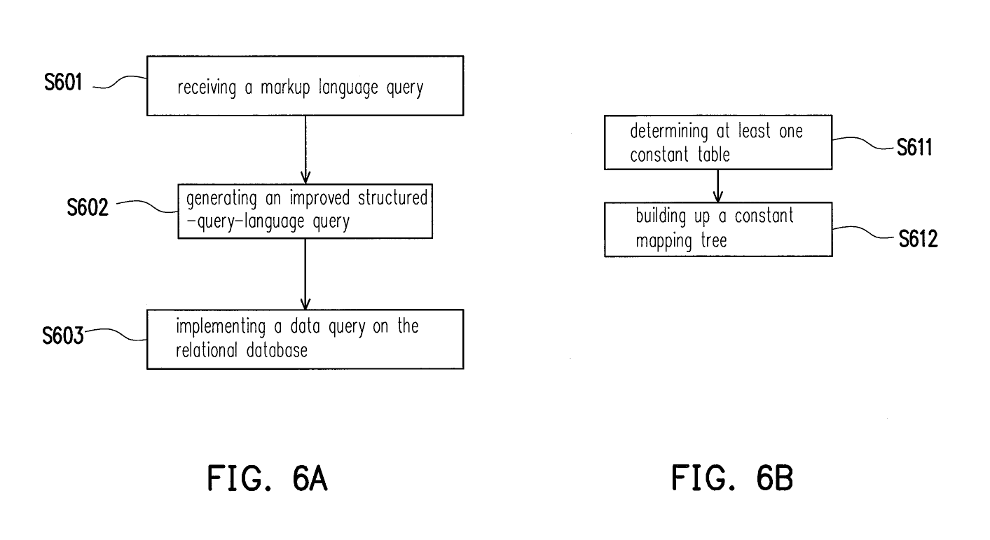

FIG. 6A is a flow chart showing a data query method according to one embodiment of the present invention. As shown in FIG. 4A and FIG. 6A, in the step S601, the query receiving module 406 receives a markup language query (through, for example, a user interface or a remote end data transmission mechanism). The markup language can be, for example, an XML query written in the XML (such as the XML Query 302 shown in FIG. 3). Then, the query generator 414 converts the markup language query into an improved structured-query-language query according to the at least constant mapping tree 405 (step S602) so as to convert the received markup language query into the improved structured-query-language query (SQL Query) capable of accessing the relational database 402. Thereafter, the query module 416 implements a data query on the relational database by using the improved SQL query (step S603).

Further, the step of implementing the data query further comprises displaying the query result of the data query by the output module 418. For instance, a user interface, such as a web page, is generated according to the query result and is transmitted to a user device, such as a computer or a portable device, to be displayed. Alternatively, the query result is directly transmitted to the user device and the transmitted query result is handled by an application software to be displayed.

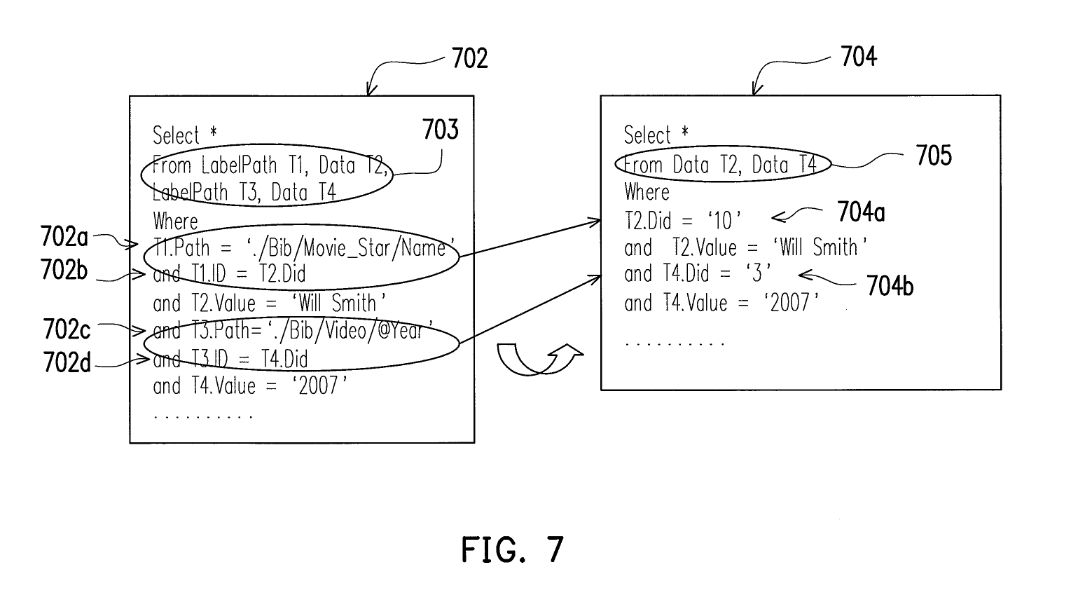

In other embodiments, as shown in FIG. 7, the process for generating an improved structured-query-language query in a query generator is illustrated. As shown in FIG. 7 and FIG. 3, the query generator 414, for example, converts the received XML query 302 (as shown in FIG. 3) into an original SQL query 702 (as shown in FIG. 7). The original SQL query 702 indicates a plurality of variables and a plurality of predicates, and then the query generator 414 performs a combining-and-replacement process on the predicates of the original SQL query 702 so as to transform the original SQL query 702 into the improved XML query 704. For instance, in the original SQL query 702, four variables 703, which denote four relational tables to be retrieved and used in the join operations, are listed, and the relational tables include the at least constant table labeled LablePath. Four variables 703 to be retrieved listed in the original SQL query can be simplified to be two variables 705. For instance, the original SQL query 702 has several predicates corresponding to the unique data of the at least constant table respectively, such as the predicates 702a, 702b, 702c and 702d. The predicates 702a, 702b, 702c and 702d are modified by referring to the node numbers of the corresponding unique data and are converted into the predicates 704a and 704b in the improved SQL query 704. In some embodiments, the combining-and-replacement process comprise: delete the at least constant table when the at least constant mapping tree is built and the title of the deleted table in original SQL; the predicates of the original SQL query are compared with the at least constant mapping tree so as to determine whether the predicates of the original SQL query comply with the unique data in the constant mapping tree; and if the predicates of the original SQL query comply with the unique data in the constant mapping tree, the variables in the predicates of the SQL query are replaced by the ID corresponding to the unique data and the predicates are combined with each other according to the replaced variables to decrease the number of the join operations. Hence, the new predicates of SQL query is generated. That is, the query variables, such as the expressions or the variables representing the relational tables (which are re-named as table variables hereafter), obtained by the join operations in the conventional technique can be directly replaced by the node number of the at least constant mapping tree, and the node number is corresponding to the unique data, and the original SQL query is converted into the improved SQL query. In another embodiment, the query generator 414 modifying the markup language query to be the improved SQL query is based on the principle of decreasing the number of the join operations of the relational tables of the original SQL query. That is, in the join operations in the original SQL query, the queries of the unique data in the at least constant table are modified by implementing a data searching on the at least constant mapping tree to obtain the corresponding node numbers. Since the node numbers correspond to the unique data of the at least constant table, the node numbers are used for replacing portions of the expressions and table variables in the predicates. Thus, the improved SQL query with less join operations is generated.

Moreover, the other embodiment of the present invention provides a method for building up a constant mapping tree 405, as shown in FIG. 4B and FIG. 6B. In the step S611, the uniqueness determining module 410 is used to determine at least one of the relational tables 404 in the relational database 402 is the at least constant table. The at least constant table stores a plurality of unique data. In the present embodiment, by checking a data schema of the relational database, at least one of the relational tables is regarded as the at least constant table. In other words, each of the data stored in the at least constant table has a feature of uniqueness. That is, there is no foreign key set in the at least constant table. More clearly, no foreign is set on each of the data in the at least constant table and none of the data in the at least constant table refers to other relational tables.

In the present embodiment, as shown in FIG. 5, in the path table 504 for recording the hierarchy path of each of the data in the XML database 500, each of the recorded data representing a hierarchy path 504a has a one-on-one feature so that the path table 504 is regarded as the at least constant table after the uniqueness determining module 410 checks the data schema of the relational database.

Then, as shown in FIG. 4B and FIG. 6B, the constant-mapping-tree building module 412, in the step S612, builds up a constant mapping tree 405 in the data query system 400 according to the determined constant table 504. When the relational database 402 comprises more than one constant table 405, the at least constant mapping trees corresponding to the at least constant tables are built respectively. The at least constant mapping tree has a plurality of tree nodes with node numbers respectively, and each of the node numbers corresponds to one of the unique data 504a in the at least constant table 504 respectively. Moreover, the constant-mapping-tree building module 412 further uses the unique identification numbers respectively corresponding to the unique data in the at least constant table as the node numbers of the tree nodes of the at least constant mapping tree respectively.

In the present embodiment, the at least constant mapping tree can be built up according to a searching tree algorithm, such as the binary searching tree algorithm. In another embodiment, the at least constant mapping tree can be built up according to the balanced binary searching tree algorithm. Preferably, the searching tree algorithm can be, for example, the red-black tree algorithm.

Further, in the other embodiment, the node hierarchy relationship between the tree nodes of the at least constant mapping tree complies with the hierarchy path represented by each of the unique data. In other words, the node hierarchy relationships of the at least constant mapping tree can be built up according to the data hierarchy relationships in the contents of the unique data. For instance, the unique data 504a are /Big, /Bug/Video, /Bug/Video/@year, and so on, and the data hierarchy relationships exist between the unique data, and the node hierarchy relationships of the at least constant mapping tree can be built up according to the data hierarchy relationships between the unique data. Thus, the node hierarchy relationships exist between the tree nodes of the at least constant mapping tree, and the node hierarchy relationships correspond to the data hierarchy relationships between the unique data respectively.

In the other embodiments, the node hierarchy relationships between the tree nodes of the at least constant mapping tree can also be built up based on the purpose of rapidly searching the unique data. For instance, the node hierarchy relationships between the tree nodes of the at least constant mapping tree can be built up according to the numerical sizes of the unique data, the numbers of words of the unique data, the number of strokes of words of the unique data, the alphabetical order of the unique data, the numerical sizes of binary data converted from the unique data in the corresponding constant table or other standards for determining the relationships between the unique data. Furthermore, as for the number of strokes of words/characters, the words or the characters are not limited to the Chinese characters. That is, the words/characters can be the words in any languages as long as the words are written with the concept of strokes.

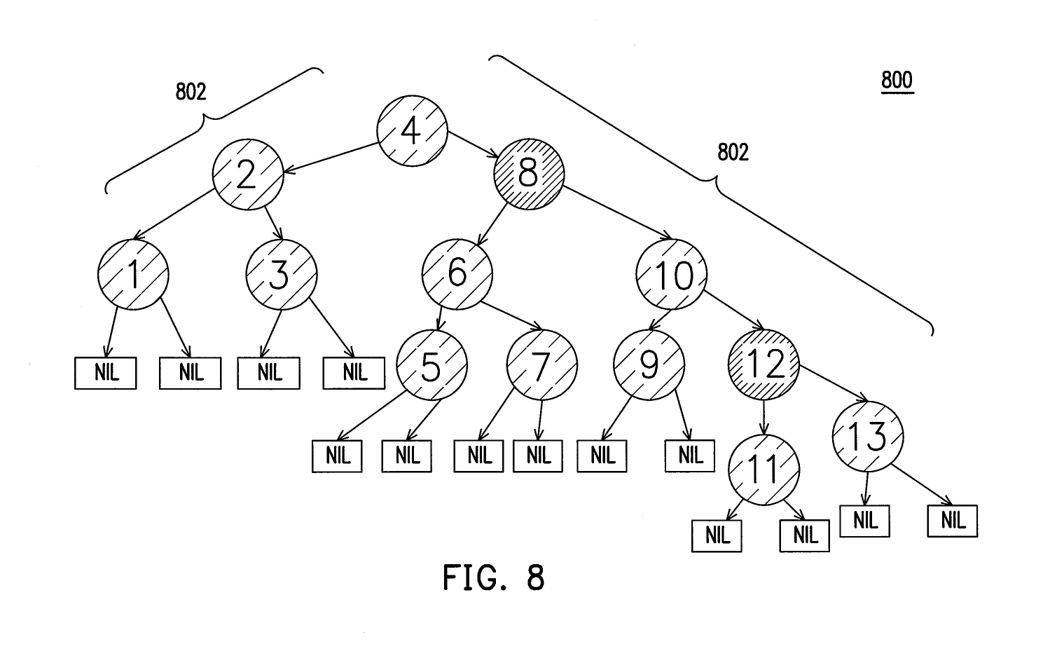

FIG. 8 is a structural schematic view of a constant mapping tree built by using red-black tree algorithm according to one embodiment of the present invention. As shown in FIG. 8, in the present embodiment, the constant-mapping-tree building module 412, in the step S611, for example, applies the red-black tree algorithm to build up a constant mapping tree. In assuming the unique data are the numbers from 1 to 13, a constant mapping tree 800 is built up, according to the numerical sizes of the unique data respectively, by arranging the unique datum with a relatively large numerical size at the right of the constant mapping tree 800 and the unique datum with a relatively small numerical size at the left of the constant mapping tree 800.

Moreover, under the circumstance that the at least constant table in the relational database is changed (for example, the at least constant table is updated or modified) or a new constant table is added in the relational database, the aforementioned process for building up a constant mapping tree can be still applied to re-build or modify the at least constant mapping tree.

In the aforementioned embodiment, the data query method of the invention may be implemented by executing a computer readable program and the data query system may also be the aforementioned computer readable program/data query program. The computer readable program is stored in a computer readable and writable recording medium and is used to execute a plurality of commands or programming codes for implementing the data query method of the present invention. The executed steps of the data query method are clearly described in the aforementioned embodiments, and thus no further description is provided herein.

According to the above descriptions, in the present invention, the received markup language query is converted into an original SQL query, and then portions of the variables and the expressions in the predicates in the original SQL query are combined and further replaced by the node numbers of the at least constant mapping tree so that the original SQL query is converted into the improved SQL query with less join operations. Thus, the data query rate of the relational database is increased and the time for waiting for the data query is decreased. Hence, the performance of the data query system is improved and the data query system becomes more user-friendly. Further, the user satisfaction is increased as well.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A data query method of a relational database, adapted for a query system to query the relational database through at least a constant mapping tree, wherein the relational database has a plurality of relational tables, the relational tables includes at least a constant table recording a plurality of unique data, each of the at least constant mapping tree corresponds to one of the at least constant tables respectively and has a plurality of tree nodes, and each of the tree nodes has a node number and each of the node numbers corresponds to one of the unique data in the at least constant table respectively, the data query method comprising:
receiving an extensible-markup-language query;
converting the extensible-markup-language query into an improved structured-query-language query according to the at least constant mapping tree; and
implementing a data query on the relational database by using the improved structured-query-language query.

2. The data query method of claim 1, wherein converting the extensible-markup-language query into the improved structured-query-language query comprises:
converting the extensible-markup-language query into an original structured-query-language query, wherein the original structured-query-language query has a plurality of predicates; and
combining and replacing a portion of the predicates corresponding to the unique data in the at least constant table by the node numbers of the unique data corresponding to the portion of the predicates.

3. The data query method of claim 1, wherein there is no foreign key set in the at least constant table.

4. The data query method of claim 1, wherein each of the node numbers corresponds to a unique identification number of each of the unique data respectively.

5. The data query method of claim 1, further comprising displaying a query result of the data query.

6. The data query method of claim 1, wherein the at least constant mapping tree is built up according to the corresponding constant table and a searching tree algorithm.

7. The data query method of claim 1, wherein the relational database is built up according to an extensible-markup-language database, a data hierarchy relationship exists between the unique data in the at least constant table, a node hierarchy relationship exists between the tree nodes of the at least constant mapping tree, and the node hierarchy relationship corresponds to the data hierarchy relationship between two unique data corresponding to the two tree nodes respectively.

8. The data query method of claim 1, wherein a node hierarchy relationship exists between the tree nodes of the at least constant mapping tree, and the node hierarchy relationship is built up according to the numerical sizes of the unique data, the numbers of words of the unique data, the number of strokes of words of the unique data, the alphabetical order of the unique data or numerical sizes of binary data converted from the unique data in the corresponding constant table.

9. A data query system of a relational database, wherein the relational database has a plurality of relational tables, and the relational tables includes at least a constant table recording a plurality of unique data, the data query system comprising:
a query receiving module for receiving an extensible-markup-language query;
at least a constant mapping tree, wherein each of the at least constant mapping tree corresponds to one of the at least constant tables respectively and has a plurality of tree nodes, each of the tree nodes has a node number, and each of the node numbers corresponds to one of the unique data respectively;
a query generator for converting the extensible-markup-language query into an improved structured-query-language query according to the at least constant mapping tree; and
a query module for implementing a data query on the relational database by using the improved structured-query-language query.

10. The data query system of claim 9, wherein the query generator converts the extensible-markup-language query into an original structured-query-language query, the original structured-query-language query has a plurality of predicates, and portions of the predicates corresponding to the unique data in the at least constant table are modified by referring to the node numbers of the unique data corresponding to the portion of the predicates.

11. The data query system of claim 9, wherein there is no foreign key set in the at least constant table.

12. The data query system of claim 9, wherein each of the node numbers corresponds to a unique identification number of each of the unique data respectively.

13. The data query system of claim 9, further comprising an output module for displaying a query result of the data query.

14. The data query system of claim 9, wherein the at least constant mapping tree is built up according to the corresponding constant table and a searching tree algorithm.

15. The data query system of claim 9, wherein the relational database is built up according to an extensible-markup-language database, a data hierarchy relationship exists between the unique data in the at least constant table, a node hierarchy relationship exists between the tree nodes of the at least constant mapping tree, and the node hierarchy relationship corresponds to the data hierarchy relationship between two unique data corresponding to the two tree nodes respectively.

16. The data query system of claim 9, wherein a node hierarchy relationship exists between the tree nodes of the at least constant mapping tree, and the node hierarchy relationship is built up according to numerical sizes of the unique data, the numbers of words of the unique data, the number of strokes of words of the unique data, the alphabetical order of the unique data or numerical sizes of binary data converted from the unique data in the corresponding constant table.

17. A computer readable and writable recording medium for storing a data query program, at least a constant mapping tree and a relational database, wherein the relational database has a plurality of relational tables, the relational tables includes at least a constant table recording a plurality of unique data, each of the at least constant mapping tree corresponds to one of the at least constant tables respectively, each of the at least constant mapping trees has a plurality of tree nodes, each of the tree nodes has a node number and each of the node numbers corresponds to one of the unique data respectively, and the data query program comprising:
a first programming code for receiving an extensible-markup-language query;
a second programming code for converting the extensible-markup-language query into an improved structured-query-language query according to the at least constant mapping tree; and
a third programming code for implementing a data query on the relational database by using the improved structured-query-language query.

18. The computer readable and writable recording medium of claim 17, wherein the second programming code further comprises:
converting the extensible-markup-language query into an original structured-query-language query, wherein the original structured-query-language query has a plurality of predicates; and
combining and replacing a portion of the predicates corresponding to the unique data in the at least constant table by the node numbers of the unique data corresponding to the portion of the predicates.

19. The computer readable and writable recording medium of claim 17, wherein the relational database is built up according to an extensible-markup-language database, a data hierarchy relationship exists between the unique data in the at least constant table, a node hierarchy relationship exists between the tree nodes of the at least constant mapping tree, and the node hierarchy relationship between two tree nodes corresponds to the data hierarchy relationship between two unique data corresponding to the two tree nodes respectively.

20. The computer readable and writable recording medium of claim 17, wherein a node hierarchy relationship exists between the tree nodes of the at least constant mapping tree, and the node hierarchy relationship is built up according to numerical sizes of the unique data, the numbers of words of the unique data, the number of strokes of words of the unique data, the alphabetical order of the unique data or numerical sizes of binary data converted from the unique data in the corresponding constant table.
